(19) United States
(12) Patent Application Publication
(10) Pub. No.: US 2025/0303530 A1
(43) Pub. Date: Oct. 2, 2025

(54) MANUAL AND ELECTRIC RATCHET DRIVER

(71) Applicant: THE HIVE CO., LTD., Busan (KR)

(72) Inventors: Ji Won PARK, Cheongju-si (KR); Sang Min LEE, Busan (KR)

(21) Appl. No.: 18/809,798

(22) Filed: Aug. 20, 2024

Related U.S. Application Data
(63) Continuation of application No. PCT/KR2024/007929, filed on Jun. 11, 2024.

(30) Foreign Application Priority Data
Mar. 29, 2024 (KR) 10-2024-0043641

(51) Int. Cl. B25B 21/00; B25B 23/18

(52) U.S. Cl. CPC B25B 21/004; B25B 23/18

(57) ABSTRACT

Proposed is a manual/electric ratchet driver with an added ratchet function that allows the driver to rotate in one desired direction without a worker having to take his or her hand off the driver or separate a bit connected to the driver from a workpiece, and the ability to easily change the direction of rotation with a simple lever operation.

### REFERENCE TO RELATED APPLICATIONS

This is a continuation of International Patent Application PCT/KR2024/007929 filed on Jun. 11, 2024, which designates the United States and claims priority of Korean Patent Application No. 10-2024-0043641 filed on Mar. 29, 2024, the entire contents of which are incorporated herein by reference.

### FIELD OF THE INVENTION

The present disclosure relates to a manual/electric ratchet driver and, more particularly, to a manual/electric ratchet driver with an added ratchet function that allows the driver to rotate in one desired direction without a worker having to take his or her hand off the driver or separate a bit connected to the driver from a workpiece, and the ability to easily change the direction of rotation with a simple lever operation.

### BACKGROUND OF THE INVENTION

Driving tools are used to tighten or loosen screws or bolts, and generally include cross (+) or straight (−) screwdrivers, wrenches, spanners, etc.

These tools are used to fix and disassemble device parts, and have been widely distributed in industrial sites and homes, depending on the type of work site.

Drivers can be operated manually or electrically, that is, they can be divided into manual drivers that work by hand and electric (power) drivers that use the power of an electric motor.

When using a driver, a worker rotates the driver while applying force vertically or horizontally with a slot (groove) of a screw head and a tip of the driver being engaged. Manual drivers require physical effort to perform this task directly by a worker, while electric drivers are screwdrivers equipped with a motor and are mainly used for tightening bolts.

In the case of manual screwdrivers, precise work is possible, but significant amount of physical effort and manual labor is required. In the case of electric screwdrivers, work efficiency is high, but precise work is difficult to achieve. Moreover, corded electric screwdrivers are less mobile and efficient, and cordless ones have disadvantages such as heavier weight and small charging capacity.

To solve these problems, manual/electric drivers are being used.

However, for conventional manual/electric drivers, if a worker wants to change to manual after using electric or change to electric after using manual, and if a worker needs to do work that exceeds the arm's range of motion during manual work, that is, rotate 360 degrees or do more than one turn manually, the worker has to release the hand holding the driver or separate a bit (screwdriver-insert) connected to the driver from a workpiece, which reduces the continuity of work and thus reduces work efficiency.

### SUMMARY OF THE INVENTION

The present disclosure is intended to solve the above problems occurring in the related art. An objective of the present disclosure is to provide a manual/electric ratchet driver with a ratchet function added to a screwdriver for both manual and electric use.

An objective of the present disclosure is to provide a manual/electric ratchet driver that allows a worker to easily change the rotation direction of a motor by simply manipulating a direction lever.

An objective of the present disclosure is to provide a manual/electric ratchet driver that can achieve maximum work efficiency with a simple configuration and relatively small number of parts.

In order to achieve the above mentioned objectives, there is provided a manual/electric ratchet driver including: a spindle connected to a motor to rotate and provided with a protrusion; a driving part connected to the spindle and configured to transmit rotational force to a socket coupled to a driver bit; a gear casing provided in a cylindrical shape to surround the spindle, and composed of: an opening with one side open in a longitudinal direction; and a cover forming a cylindrical shape by covering the opening; a pair of ratchet plates provided to cover the opening within the cover, and composed of: a horizontal plate including a rotating part rotatably coupled to each inner wall of the gear casing; and a protruding part configured to protrude between partial protrusions of the protrusion on the horizontal plate and to rotate or restrain the protrusion; a direction lever configured to allow one of the ratchet plates to rotate, allowing the protrusion to rotate in a forward or reverse direction; and a pair of lever springs provided on a lower surface of the direction lever and configured to press the rotating part of each of the ratchet plates to rotate, wherein when the direction lever is moved in a first direction, a first lever spring may press the rotating part of a first ratchet plate so that the protrusion of the first ratchet plate may rotate upward, rotating the protrusion in the forward direction, whereas when the direction lever is moved in a second direction, a second lever spring may press the rotating part of a second ratchet plate so that the protrusion of the second ratchet plate may rotate upward, rotating the protrusion in the reverse direction.

In addition, according to a preferred embodiment of the present disclosure, the manual/electric ratchet driver may further include a ratchet plate spring provided on a lower surface of the cover, and configured to press the pair of ratchet plates so that any rotated ratchet plate to return, wherein the ratchet plate spring may have weaker rigidity than the lever spring.

In addition, according to a preferred embodiment of the present disclosure, wherein the each of the ratchet plates may have an “L” shape and may be provided with a protrusion on each side of the horizontal plate so as to be rotatably coupled between a first groove provided on each side of the gear casing and a second groove of a corresponding portion of the cover, and the protruding parts of the ratchet plates may be provided to face each other, and may be provided in opposite directions on the respective horizontal plates.

In addition, according to a preferred embodiment of the present disclosure, the manual/electric ratchet driver may further include: a battery for supplying power to the motor; a USB charging port for charging the battery; and a lighting lamp provided at a position close to the driver bit to emit light to an end of the driver bit.

The present disclosure with the above configuration can expect the following effects.

In a manual/electric ratchet driver, since a ratchet function is added that allows the driver to rotate in one desired direction without having to remove the hand of a worker or separate a bit connected to the driver from a workpiece, work efficiency can be significantly improved.

Furthermore, the rotation direction of a motor can be easily changed by simply manipulating a direction lever, thereby improving work efficiency.

Furthermore, manual and electric operation is possible with a simple configuration and a relatively small number of parts, and a ratchet function is added to achieve maximum work efficiency.

Other effects of the present disclosure will be encompassed in a broader scope not only by the embodiments described above and in the claims of the present disclosure, but also by the effects that can arise within the scope that can be easily derived from them and the possibilities of potential advantages contributing to industrial development.

### BRIEF DESCRIPTION OF THE DRAWINGS

FIG. 1 is a perspective view showing an example of a manual/electric ratchet driver according to the present disclosure;

FIGS. 2a and 2b are a perspective view and an exploded perspective view, respectively, showing the internal configuration of the manual/electric ratchet driver according to the present disclosure;

FIGS. 3a to 3c are views showing the internal configuration of the manual/electric ratchet driver in a standby state according to the present disclosure;

FIGS. 4a to 4c are views showing the internal configuration of the manual/electric ratchet driver in a forward rotation state according to the present disclosure; and

FIGS. 5a to 5c are views showing the internal configuration of the manual/electric ratchet driver in a reverse rotation state according to the present disclosure.

### DESCRIPTION OF REFERENCE NUMERALS

100: manual/electric ratchet driver
10: spindle
15: protrusion
20: driving part
21: motor
30: gear casing
40: cover
50: ratchet plate
55: ratchet plate spring
60: direction lever
65: lever spring
70: driver-bit

### DETAILED DESCRIPTION OF THE INVENTION

Hereinafter, preferred embodiments of the present disclosure will be described in detail with reference to the attached drawings. Prior to the description, the advantages and features of the present disclosure and methods for achieving them will become clear by referring to the embodiments described in detail below along with the accompanying drawings. In addition, the terms used in this specification are for describing embodiments and are not intended to limit the present disclosure, and it should be noted that among these terms, the singular form also includes the plural form unless specifically mentioned in the phrase, and words indicating directions in the explanation are intended to aid understanding of the explanation and may change depending on the point in time.

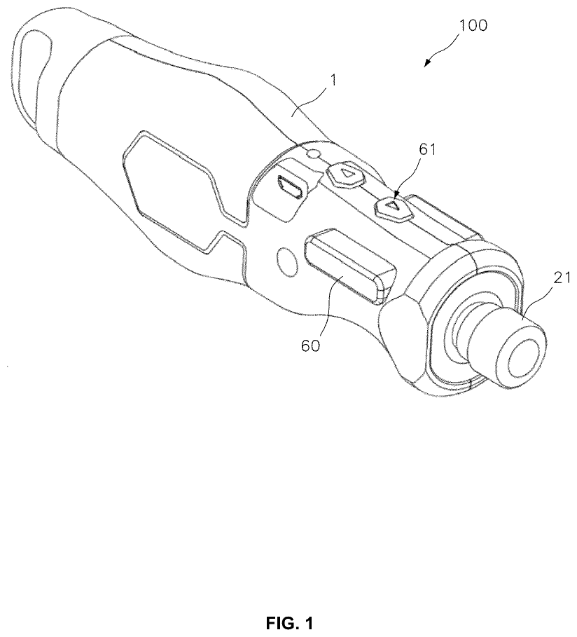

Hereinafter, a manual/electric ratchet driver according to a preferred embodiment of the present disclosure will be described in detail with reference to the attached drawings. FIG. 1 is a perspective view showing an example of a manual/electric ratchet driver according to the present disclosure.

Referring to FIG. 1, a manual/electric ratchet driver 100 according to the present disclosure is provided with a power button (not shown) and an electric operation button 61 in a driver casing 1, and a direction lever 60 and a bit holder 21 to which a driver bit (not shown) is coupled are also provided.

FIG. 1 is shown as one example, and the driver 100 is not limited to this form. The driver 100 may have the following internal configurations, and may be of any form as long as it is easy for a worker to hold and work with. The direction lever 60 may also be applied in various forms, such as a switch, a button, or twist (rotation) type, rather than a lever form.

A lighting lamp (not shown) may be provided at a position close to the driver bit to emit light to the end of the driver bit, making it easy to work in dark places or places where detailed work is required, thereby improving the worker's work efficiency.

Inside the driver casing 1, internal components according to the present disclosure are provided, that is, a motor, a gearbox, a battery, a control circuit, etc. are built in.

At this time, the battery may be a secondary battery that can supply stable power to the motor.

The built-in control circuit controls operation and charging, extending the life of the battery and enabling rapid charging.

In addition, the manual/electric ratchet driver 100 according to the present disclosure is equipped with a USB charging port, so that the battery provided in the driver casing 1 may be easily charged.

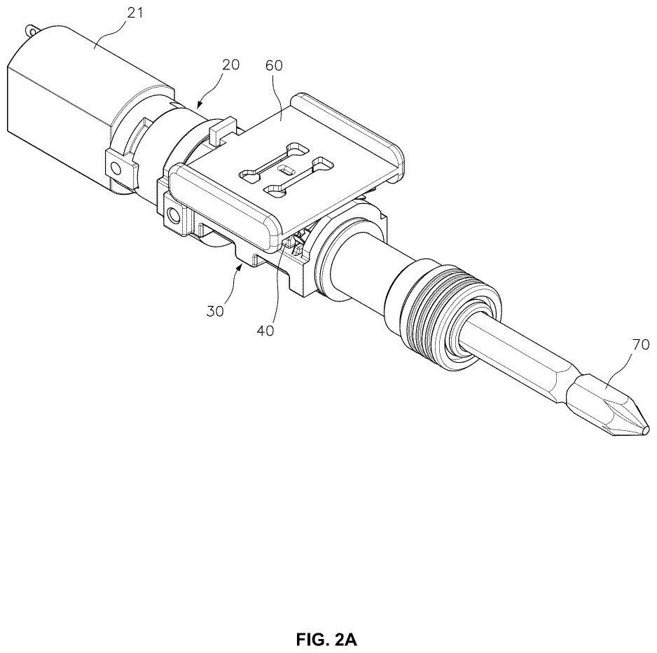

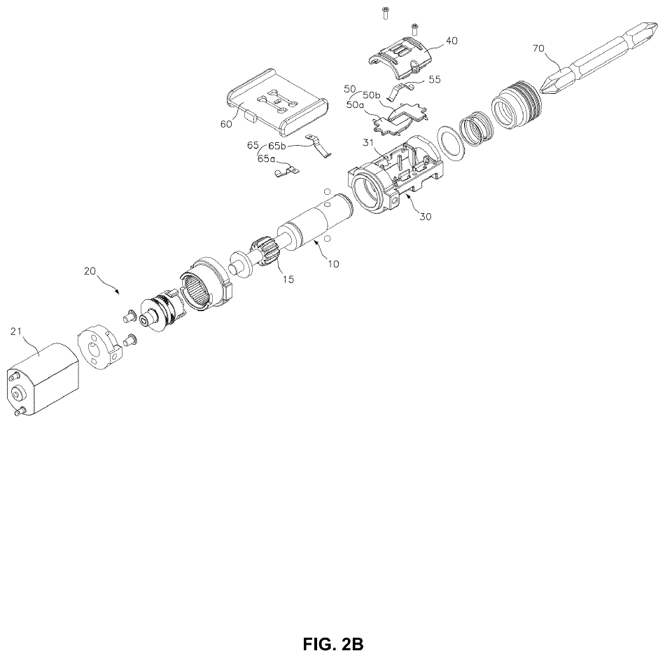

Among the internal configurations of the driver casing 1, configurations according to the characteristics of the present disclosure are shown in FIGS. 2A and 2B. FIGS. 2a and 2b are a perspective view and an exploded perspective view, respectively, showing the internal configuration of the manual/electric ratchet driver according to the present disclosure.

Referring to FIGS. 2A and 2B, the manual/electric ratchet driver 100 according to the present disclosure is provided inside the driver casing 1, and includes a spindle 10, a driving part 20, a gear casing 30, a ratchet plate 50, a ratchet plate spring 55, the direction lever 60, and a lever spring 65.

The spindle 10 is connected to the driving part 20 connected to the motor 21 to rotate, and is provided with a protrusion 15 that engages with the ratchet plate 50 and functions as a lock.

When driven electrically, the manual/electric ratchet driver 100 according to the present disclosure is driven by the motor 21, which is driven by power supplied from a power supply part.

The drive part 20 connected to the motor 21 rotates, and the spindle 10 connected thereto rotates, resulting in the driver bit 70 rotating.

The drive part 20 is connected to the spindle 10 and transmits rotational force to the driver bit 70.

As shown in FIG. 2b, the drive part 20 is a gearbox equipped with general components and may be a rotational reducer. For example, the drive part 20 is composed of a plurality of shafts, carriers, planetary gears, etc., so that the rotational force of the motor 21 is transmitted to the driver bit 70.

The drive part 20 may be provided in various configurations to control deceleration through gear ratio and increase torque efficiency accordingly.

The gear casing 30 is provided in a cylindrical shape to surround the spindle 10. The gear casing 30 includes an opening 31 whose one side is open in the longitudinal direction, and a cover 40 that covers the opening 31 and forms a cylindrical shape.

The gear case 30 allows the driving part 20 to be coupled to the protruding rear end of the spindle 10 provided inside, and ensures that the ratchet plate 50, which implements a ratchet function, is stably fixed.

Inside the gear casing 30, the spindle 10 rotates, and the protrusion 15 provided on the spindle 10, that is, the protrusion 15 that engages with the ratchet plate 50 and functions as a lock, also rotates.

In order to change the rotation direction of the protrusion 15, the ratchet plate 50, the ratchet plate spring 55, the direction lever 60, and the lever spring 65 described below are provided.

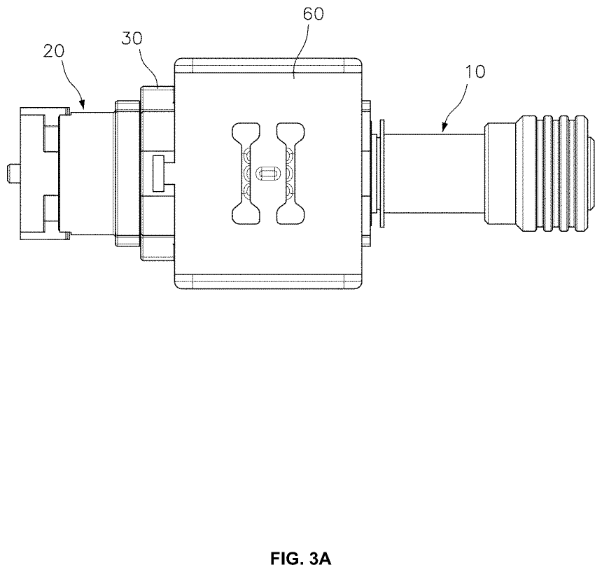

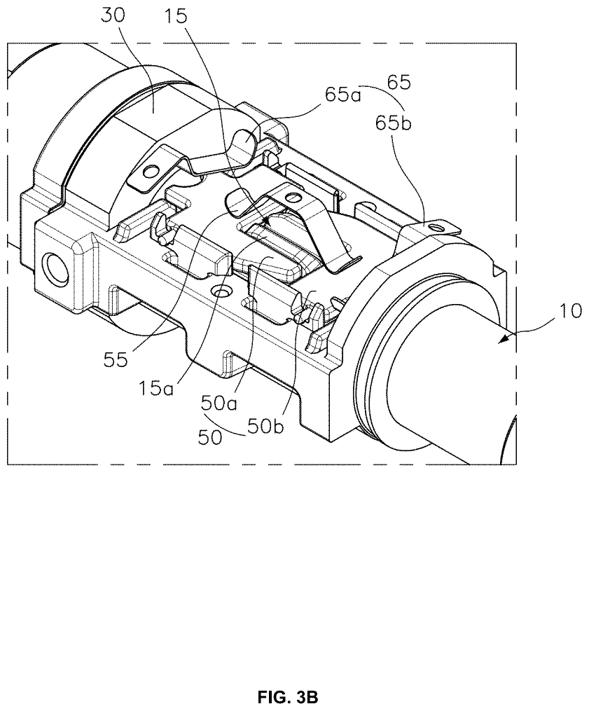

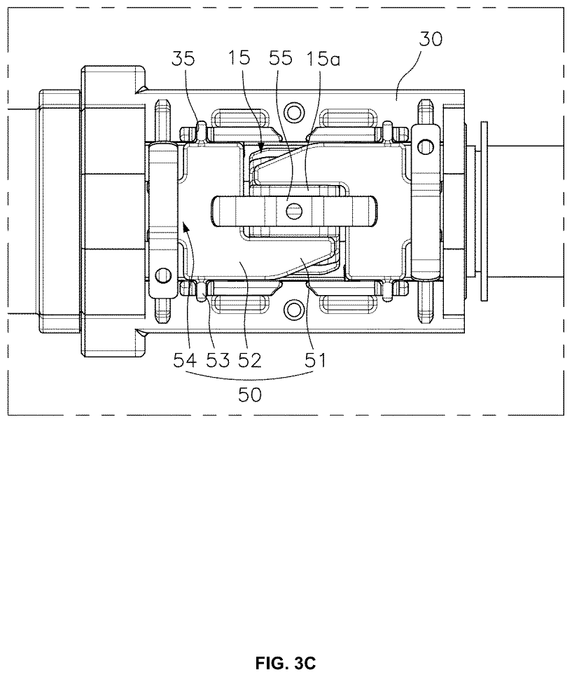

The internal structure of the gear casing 30 is shown in detail in FIGS. 3a to 3c. FIGS. 3a to 3c are views showing the internal configuration of the manual/electric ratchet driver in a standby state according to the present disclosure.

The ratchet plate 50 is provided to cover the opening 31 within the cover 40, and is provided as a pair so that the ratchet plates 50a and 50b face each other.

That is, as detailed in FIG. 3c, the ratchet plate 50 has an “L” shape and is provided with a protrusion 53 on each side of a horizontal plate 52 so as to be rotatably coupled between first grooves 35 provided on opposite sides of the gear casing 30 and second grooves (not shown) of the corresponding portion of the cover 40.

Each of the ratchet plates 50a and 50b has a protruding part 51 that protrudes from the horizontal plate 52, and the protruding part 51 protrudes between partial protrusions 15a of the protrusion 15 to rotate or constrain the protrusion 15.

At this time, respective protruding parts 51 of the ratchet plates 50a and 50b are provided to face each other and are provided in opposite directions on the respective horizontal plates 52.

That is, based on FIGS. 3b and 3c, the first ratchet plate 50a is provided with the protruding part 51 at the lower portion of the horizontal plate 52, while the second ratchet plate 50b is provided with the protruding part 51 at the upper portion of the horizontal plate 52.

In addition, the ratchet plate 50 includes a rotating part 54 that is provided with a protrusion 53 between the first groove 35 and the second groove.

The rotating part 54 is a portion to which the ratchet plate 50 is rotatably coupled within the gear casing 30, and is the opposite portion of the horizontal plate 52 to which the protruding part 51 is provided.

Each of the rotating parts 54 of the ratchet plate 50 is provided with the lever spring 65 at the top. As the rotating part 54 of one ratchet plate 50 is pressed by the lever spring 65 and the protruding part 51 of the ratchet plate 50 is rotated, the rotation direction of the protrusion 15 may be changed, which will be described below.

Meanwhile, the ratchet plate 50 is provided with the ratchet plate spring 55 on the horizontal plates 52, and the ratchet plate spring 55 has an elastic force to apply a force to press the ratchet plate 50 downward.

That is, the ratchet plate spring 55 presses the ratchet plate 50 when the ratchet plate 50 is rotated due to the movement of the direction lever 60, and allows the ratchet plate 50 to return to its original position when the direction lever 60 is returned.

At this time, the ratchet plate spring 55 needs to be less rigid than the lever spring 65 because when the direction lever 60 is moved for rotation in a specific direction, the ratchet plate 50 should remain rotated in order to proceed with work while maintaining rotation in that direction.

In this case, although the ratchet plate spring 55 is shown as an example of an elastic leaf spring, the ratchet plate spring 55 is not limited to this form and may be of any shape as long as it is an elastic spring.

The direction lever 60 allows any one of the ratchet plates 50 described above to rotate, allowing the protrusion 15 to rotate in the forward or reverse direction.

The direction lever 60 is provided with a pair of lever springs 65 (65a, 65b) on the lower surface thereof, and each lever spring 65 presses the rotating part 54 of each ratchet plate 50 to rotate.

That is, referring to FIG. 3b, a hole provided on one side of the first lever spring 65a is coupled with a protrusion (not shown) provided on a corresponding portion of the lower surface of the direction lever 60, and a hole provided on the other side of the second lever spring 65b is coupled with a protrusion (not shown) provided on a corresponding portion of the lower surface of the direction lever 60.

Due to the coupling of the direction lever 60 and the lever springs 65, the movement of the direction lever 60, that is, movement in one direction or the other direction, causes the first lever spring 65a or the second lever spring 65b to be pressed.

In this case, although the lever spring 65 is shown as an example of an elastic leaf spring, the lever spring 65 is not limited to this form and may be of any shape as long as it is an elastic spring.

The first lever spring 65a provided on the lower surface of the direction lever 60 is provided on the rotating part 54 of the first ratchet plate 50a. The second lever spring 65b provided on the lower surface of the direction lever 60 is provided on the rotating part 54 of the second ratchet plate 50b.

Due to the movement of the direction lever 60, the first lever spring 65a presses the rotating part 54 of the first ratchet plate 50a to rotate the first ratchet plate 50a, or the second lever spring 65b presses the rotating part 54 of the second ratchet plate 50b to rotate the second ratchet plate 50b.

In this case, although the direction lever 60 is shown as an example of being moved in a straight direction, the direction lever 60 is not limited to this form and may take various forms such as a switch or twist type.

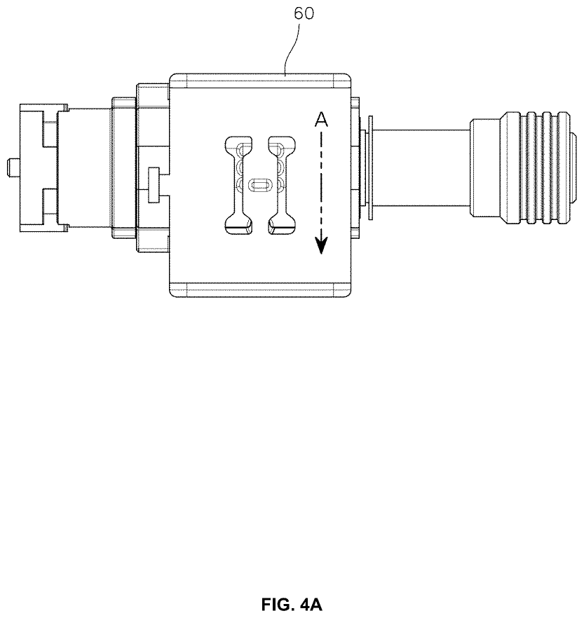

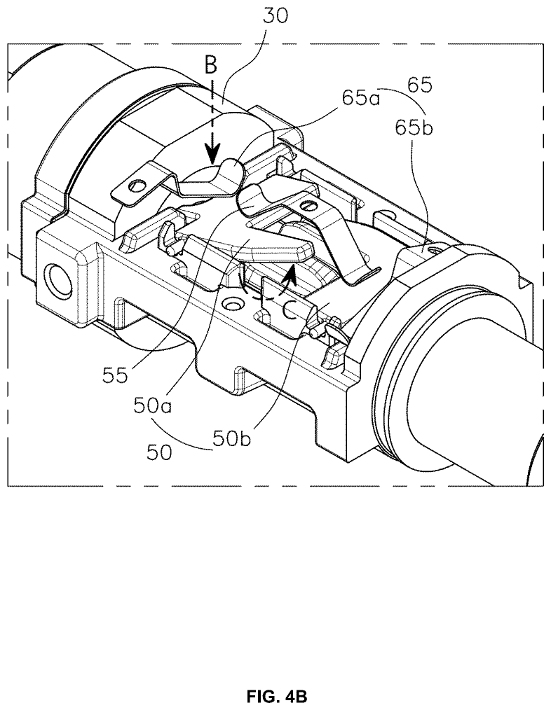

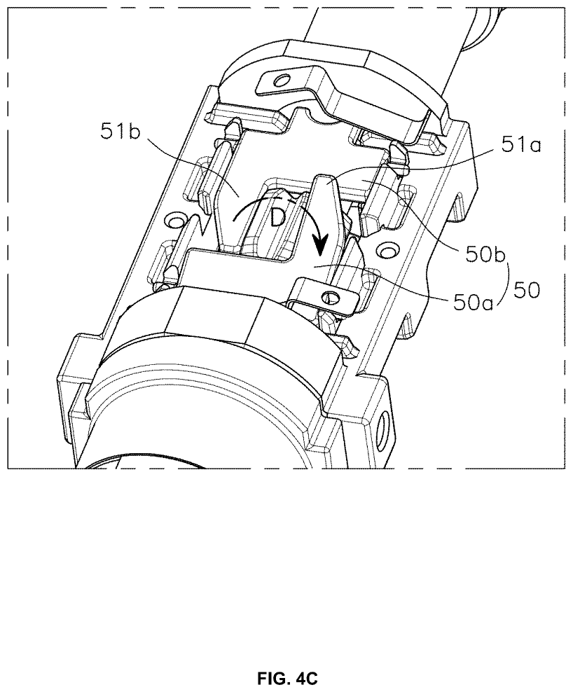

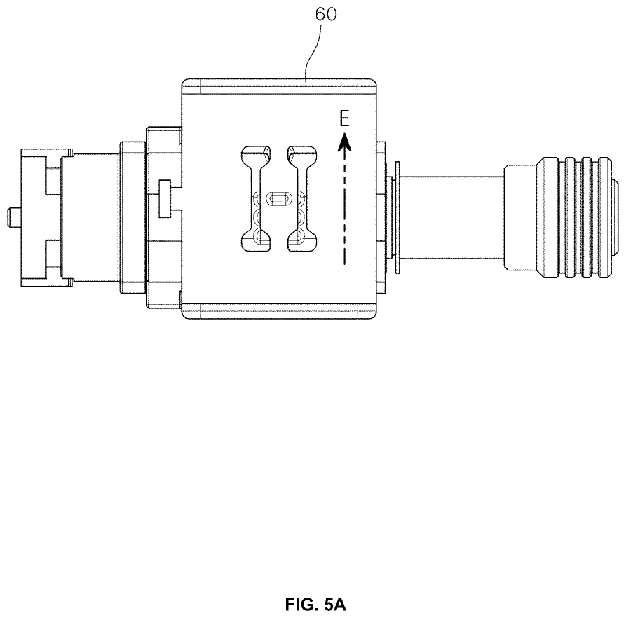

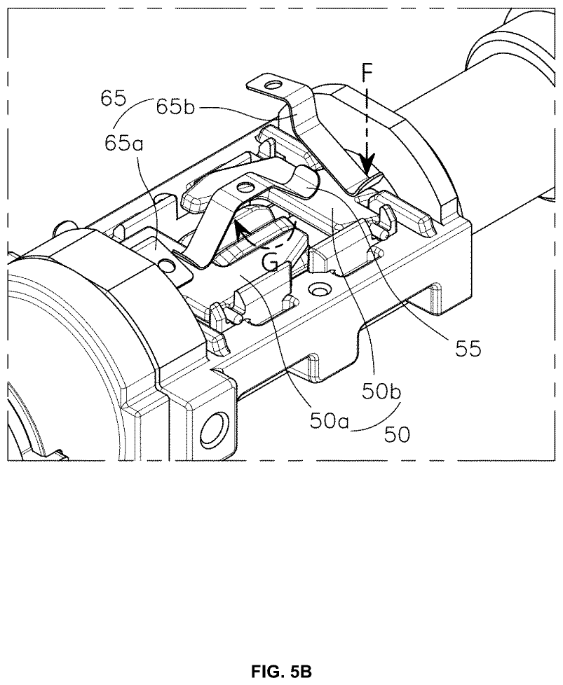

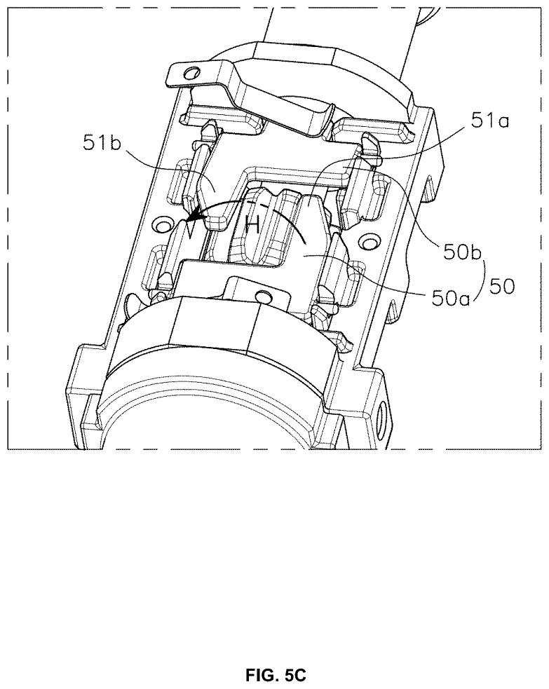

FIGS. 4a to 4c and 5a to 5c show the forward or reverse rotation state of the protrusion 15 due to movement of the direction lever 60.

FIGS. 4a to 4c are views showing the internal configuration of the manual/electric ratchet driver in a forward rotation state according to the present disclosure, and FIGS. 5a to 5c are views showing the internal configuration of the manual/electric ratchet driver in a reverse rotation state according to the present disclosure.

That is, as shown in FIG. 4a, when the direction lever 60 is moved in one direction, for example, downward as shown by arrow A in the drawing, the protrusion 15 rotates in the forward direction as shown by arrow D in FIG. 4c.

At this time, due to the movement of the direction lever 60, as shown in FIG. 4b, the lever spring 65, for example, the first lever spring 65a, is pressed downward as indicated by arrow B and rotates the first ratchet plate 50a as indicated by arrow C.

In addition, as shown in FIG. 4b, since the second ratchet plate 50b is maintained in a standby state, the protruding part 51 of the second ratchet plate 50b is between the partial protrusions 15a of the protrusion 15.

In this way, the rotated first ratchet plate 50a does not affect the rotation of the protrusion 15, the second ratchet plate 50b restrains the protrusion 15 from rotating in the reverse direction, and when the protrusion 15 rotates in the forward direction, the second ratchet plate 50b is lifted and rotated by the partial protrusions 15a.

That is, as shown in FIG. 4c, the protrusion 15 rotates only in the forward direction as shown by arrow D.

On the other hand, as shown in FIG. 5a, when the direction lever 60 is moved in the other direction, for example, upward as shown by arrow E in the drawing, the protrusion 15 rotates in the reverse direction as shown by arrow H in FIG. 5c.

At this time, due to the movement of the direction lever 60, as shown in FIG. 5b, the lever spring 65, for example, the second lever spring 65b, is pressed downward as indicated by arrow F and rotates the second ratchet plate 50b as indicated by arrow G.

In addition, as shown in FIG. 5b, since the first ratchet plate 50a is maintained in a standby state, the protruding part 51 of the first ratchet plate 50a is between the partial protrusions 15a of the protrusion 15.

In this way, the rotated second ratchet plate 50b does not affect the rotation of the protrusion 15, the first ratchet plate 50a restrains the protrusion 15 from rotating in the forward direction, and when the protrusion 15 rotates in the reverse direction, the first ratchet plate 50a is lifted and rotated by the partial protrusions 15a.

That is, as shown in FIG. 5c, the protrusion 15 rotates only in the reverse direction as shown by arrow H.

The above description is merely an illustrative explanation of the technical idea of the present disclosure, and those skilled in the art will be able to make various modifications, changes, and substitutions without departing from the essential characteristics of the present disclosure. As described above, the embodiments disclosed in the present disclosure and the accompanying drawings are not intended to limit the technical idea of the present disclosure but are for illustrative purposes only, and the scope of the technical idea of the present disclosure is not limited by these embodiments and the attached drawings. The scope of protection of the present disclosure should be interpreted in accordance with the claims below, and all technical ideas within the equivalent scope should be interpreted as being included in the scope of rights of the present disclosure.

What is claimed is:

1. A manual/electric ratchet driver, comprising:
a spindle connected to a motor to rotate and provided with a protrusion;
a driving part connected to the spindle and configured to transmit rotational force to a socket coupled to a driver bit;
a gear casing provided in a cylindrical shape to surround the spindle, and composed of: an opening with one side open in a longitudinal direction; and a cover forming a cylindrical shape by covering the opening;
a pair of ratchet plates provided to cover the opening within the cover, and composed of: a horizontal plate including a rotating part rotatably coupled to each inner wall of the gear casing; and a protruding part configured to protrude between partial protrusions of the protrusion on the horizontal plate and to rotate or restrain the protrusion;
a direction lever configured to allow one of the ratchet plates to rotate, allowing the protrusion to rotate in a forward or reverse direction; and
a pair of lever springs provided on a lower surface of the direction lever and configured to press the rotating part of each of the ratchet plates to rotate,
wherein when the direction lever is moved in a first direction, a first lever spring presses the rotating part of a first ratchet plate so that the protrusion of the first ratchet plate rotates upward, rotating the protrusion in the forward direction, whereas when the direction lever is moved in a second direction, a second lever spring presses the rotating part of a second ratchet plate so that the protrusion of the second ratchet plate rotates upward, rotating the protrusion in the reverse direction.

2. The manual/electric ratchet driver of claim 1, further comprising:
a ratchet plate spring provided on a lower surface of the cover, and configured to press the pair of ratchet plates so that any rotated ratchet plate to return,
wherein the ratchet plate spring has weaker rigidity than the lever spring.

3. The manual/electric ratchet driver of claim 1, wherein the each of the ratchet plates has an “L” shape and is provided with a protrusion on each side of the horizontal plate so as to be rotatably coupled between a first groove provided on each side of the gear casing and a second groove of a corresponding portion of the cover, and
the protruding parts of the ratchet plates are provided to face each other, and are provided in opposite directions on the respective horizontal plates.

4. The manual/electric ratchet driver of claim 1, further comprising:
a battery for supplying power to the motor;
a USB charging port for charging the battery; and
a lighting lamp provided at a position close to the driver bit to emit light to an end of the driver bit.
